(19) United States
(12) Patent Application Publication
(10) Pub. No.: US 2012/0249880 A1
(43) Pub. Date: Oct. 4, 2012

(54) METHOD AND APPARATUS FOR DETECTING CAMERA MOTION TYPE IN VIDEO

(75) Inventors: Fei LI, Beijing (CN); Rujie LIU, Beijing (CN); Hao YU, Beijing (CN); Takayuki BABA, Kawasaki (JP); Yusuke UEHARA, Kawasaki (JP)

(73) Assignee: FUJITSU LIMITED, Kawasaki (JP)

(21) Appl. No.: 13/434,310

(22) Filed: Mar. 29, 2012

(30) Foreign Application Priority Data
Mar. 31, 2011 (CN) 201110085697.3

(51) Int. Cl. H04N 5/14

(52) U.S. Cl. 348/700; 348/E07.007

(57) ABSTRACT

Embodiments disclose a method and apparatus for detecting a camera motion type in a video, the method including: estimating a first zoom motion parameter between adjacent frames in the video; estimating a second zoom motion parameter between frames having an interval of a preset number in a corresponding video segment when the first zoom motion parameter meets a first preset condition; and identifying the camera motion type of the video segment as slow zoom when the second zoom motion parameter meets a second preset condition. With the embodiments of the invention, the motion type of a camera in the video can be detected more effectively and accurately.

### CROSS REFERENCE TO RELATED APPLICATIONS

This application claims the benefit of Chinese Application No. 201110085697.3, filed Mar. 31, 2011, the disclosure of which is incorporated herein by reference.

### FIELD

The embodiments generally relate to the filed of video data processing and in particular to a method and apparatus for detecting a camera motion type in a video.

### BACKGROUND

An effective video management and analysis system has been desired for people in many aspects in their daily life along with a sharply increasing number of digital video files. With the aid of this system, people can organize video files in a personal computer more conveniently, urban traffic can be controlled effectively and video surveillance can also detect easily an abnormal event, e.g., inbreaking of a stranger, etc.

A video file is acquired from photographing by a photographer using a camera (possibly a specialized camera or a terminal device capable of photographing, e.g., a mobile phone, a portable computer, etc). Some actions of zooming, panning the camera or the like may be performed as necessary during photographing, and these actions correspond to the motion of the camera so that different actions correspond to different types of motion. Typically a video file may include a variety of types of motion because the photographer may need to perform different adjustment (e.g., firstly translating, then focusing and next resting, etc.) during photographing.

The photographer adjusts the camera primarily in view of the extent of importance of an object of interest. For example, when the photographer puts an emphasis on photographing the action of a remote person, he or she may zoom in the camera after a lens is directed to the person to scale up the person displayed in a scene. Correspondingly if a video file contains the type of focusing motion or the like, then the contents of the part of a video corresponding to the type of motion shall typically be of particular interest to the photographer and therefore may be important contents of the video file and even primary contents capable of representing the video file. The contents of this part can be extracted for a summary of the video file.

Therefore effective detection of camera motion has become crucial to the video management and analysis system. Based upon the motion type of a camera during acquisition of a video, the video can be browsed more conveniently and primary contents of the video can be acquired more easily, and furthermore a summary of the video file can be acquired conveniently to serve further retrieval of the video file, etc.

The existing video management and analysis system can analyze the motion type of a camera from a video file and further acquire high-level information, e.g., photographic intention, etc. However some special instances tend to fail to be detected accurately or a detection error may occur while analyzing the motion type of the camera from the video file in the prior art.

### SUMMARY

In view of this, embodiments provide a method and apparatus for detecting a camera motion type in a video to detect more effectively and accurately the motion type of the camera in the video.

According to an aspect of the embodiments, there is provided a method for detecting a camera motion type in a video, which includes: estimating a first zoom motion parameter between adjacent frames in the video; estimating a second zoom motion parameter between frames having an interval of a preset number in a corresponding video segment when the first zoom motion parameter meets a first preset condition; and identifying the camera motion type of the video segment as slow zoom when the second zoom motion parameter meets a second preset condition.

According to another aspect of the embodiments, there is provided another method for detecting a camera motion type in a video, which includes: acquiring zoom motion parameters in the video; detecting a video segment in which the camera motion type is focusing from the video according to the zoom motion parameters; calculating a focal point position of each frame in the video segment; and verifying the detection result of the video segment according to the focal point position of each frame.

According to a further aspect of the embodiments, there is provided an apparatus for detecting a camera motion type in a video, which includes: a first estimating unit, configured to estimate a first zoom motion parameter between adjacent frames in the video; a second estimating unit, configured to estimate a second zoom motion parameter between frames having an interval of a preset number in a corresponding video segment when the first zoom motion parameter meets a first preset condition; and a determining unit, configured to identify the camera motion type of the video segment as slow zoom when the second zoom motion parameter meets a second preset condition.

According to another aspect of the embodiments, there is provided an apparatus for detecting a camera motion type in a video, which includes: a motion parameter acquiring unit, configured to acquire zoom motion parameters in the video; a motion type detecting unit, configured to detect a video segment in which the camera motion type is focusing in the video according to the zoom motion parameters; a focal point position calculating unit, configured to calculate a focal point position of each frame in the video segment; and a detection result verifying unit, configured to verify the detection result of the video segment according to the focal point position of each frame.

Furthermore according to another aspect, there is also provided a storage medium including machine readable program codes which when executed on an information processing device causes the information processing device to perform the foregoing methods for detecting the camera motion type in a video.

Furthermore according to a further aspect, there is also provided a program product including machine executable instructions which when executed on an information processing device causes the information processing device to perform the foregoing methods for detecting the camera motion type in a video.

With the foregoing methods according to the embodiments, the motion type of slow zooming can be detected in a “dual zoom motion parameters” way, where firstly the first zoom motion parameter between adjacent frames is estimated, and then in the case that the parameter meets the first preset condition, the second zoom motion parameter between every other several frames is further estimated, and if the second zoom motion parameter meets the second preset condition, then the camera motion type can be identified as slow zooming in the video segment corresponding to these frames. Apparently the motion type of slow zooming can be identified accurately with the methods according to the embodiments.

Furthermore in the embodiments, the detection result of the camera motion type in the video file is acquired with the motion parameters, and then for the video segment with the detection result of focusing, the positions of focal points of respective frames in the video segment are further calculated, and then the detection result of the video segment is verified in view of the positions of the focal points of the respective frames. Apparently with the embodiments, whether the motion type corresponding to the video segment is focusing motion indeed can be further verified, thereby improving the accuracy of detection.

Other aspects of the embodiments will be presented in the following detailed description serving to fully disclose preferred embodiments of the invention but not to limit the invention.

### BRIEF DESCRIPTION OF DRAWINGS

The foregoing and other objects and advantages of the embodiments will be further described below in conjunction with the specific embodiments with reference to the drawings in which identical or corresponding technical features or components will be denoted with identical or corresponding reference numerals and in which:

FIG. 1 is a flow chart illustrating a first method according to an embodiment;

FIG. 2 is a flow chart illustrating a second method according to an embodiment;

FIG. 3 is a schematic diagram illustrating a first apparatus according to an embodiment;

FIG. 4 is a schematic diagram illustrating a second apparatus according to an embodiment; and

FIG. 5 is a block diagram illustrating an illustrative structure of a personal computer of an information processing device used in an embodiment.

### DESCRIPTION OF EMBODIMENTS

Embodiments will be described below with reference to the drawings.

Firstly the inventors have identified during implementation of the embodiments that detection of the motion type of a camera in a video in the method of the prior art suffers from at least the following problems:

On one hand, the type of zoom motion is generally detected in the prior art as follows: a zoom motion parameter between adjacent frames in a video is estimated, and if the zoom motion parameter is above a certain preset threshold, then a feature of the type of zoom motion is met, and furthermore it can be determined that the motion type of a camera is zooming in a video segment composed of the corresponding frames. Apparently the selection of the threshold is of such importance to detection of the type of zoom motion in this method that the threshold shall be neither too high nor too low because if it is too high, then a type of motion which would otherwise be detected as the type of zoom motion can not be detected, and if it is set too low, then considerable noise may be incurred, that is, other type of motion than the type of zoom motion may be detected as the type of zoom motion. Therefore a standard threshold for use in detection is typically set to a moderate value based upon the frame rate of the video and by detecting standard zoom motion.

Apparently this detection method works well for standard zoom motion, but slow zooming may arise in a practical application, that is, a user may zoom so slowly while acquiring the video by photographing that a significant zoom feature is absent in the corresponding video segment, and furthermore the zoom motion parameter between the adjacent frames is below the preset threshold in detection with the method of the prior art, so the motion type of the camera in this video segment can not be identified as zooming, and apparently this is inconsistent with the real situation, resulting in an error.

On the other hand, a photographed scene is typically required in normal photographing of a video to remain as parallel as possible with a focal plane of the camera. However some amateurish video photographer may have the photographed scene unparallel with the focal plane of the camera while capturing the video using the camera. If the camera is subject to translational motion in this case, then an object will be enlarged gradually in the video acquired by photographing as is very similar to focusing on a segment. As a result, such translational motion of the declining camera may be mistaken for focusing motion in detection of the video file in the foregoing method for identifying the type of zoom motion, and apparently this may also result in an error.

Corresponding solutions to the foregoing two problems present in the prior art are provided in the embodiments and will be described in details below.

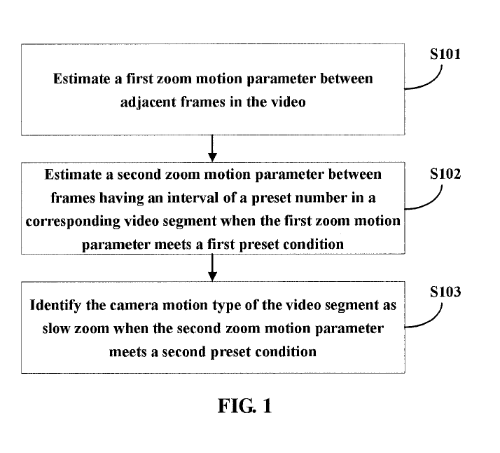

Firstly referring to FIG. 1, a first method for detecting a camera motion type in a video according to an embodiment includes the following steps.

The step S101 is to estimate a first zoom motion parameter between adjacent frames in the video by a first estimating unit.

The step of estimating a zoom motion parameter between adjacent frames can be performed as in the method of the prior art. For example, each frame of the video can be divided into a number of image blocks, and a motion vector of each image block can be determined in a local searching method. Then global motion of a motion vector field can be described in the following affine model including six parameters:

$$\{ \begin{matrix}u = {a}_{1} + {a}_{2} x + {a}_{3} y \\ v = {a}_{4} + {a}_{5} x + {a}_{6} y\end{matrix} \qquad ( 1 )$$

Where (x, y) represents the position of an image block and is known, and (u, v) represents a motion vector of the image block. These six parameters in the model can be determined from the positions of image blocks in the same frame and information on their corresponding motion vectors using the least squaring method or the like. Then the motion parameter of the camera can be calculated from a correspondence relationship between the motion parameter of the camera and these six parameters in the model.

Particularly the correspondence relationship between a motion parameter corresponding to zooming of the camera and the parameters in the model is as follows:

div=0.5(a₂+a₆) (2)

In the formula (2), div represents the motion parameter corresponding to zooming of the camera and will be referred simply to as a zoom motion parameter for convenience of the description. It can be further detected with the zoom motion parameter whether a segment with the camera motion type being zooming is present in the video after the zoom motion parameter is acquired. For example when a_{z} and a₆ have the same sign (both are positive or negative), div is compared with a preset threshold, and it is determined from the result of comparison whether a corresponding motion type of the camera is zooming.

It shall be noted that a video is actually composed of a number of frames of still images, and therefore the concept of a motion parameter of the camera relates to motion and thus can not be embodied in a separate frame of image. Therefore the motion parameter is actually calculated from a relative positional relationship of an image block between different frames. Thus the concept of “motion vector” as mentioned above refers to a motion vector between two frames in the video acquired by analyzing the two frames. Furthermore the concept of a motion parameter of the camera also refers to a motion parameter of the camera acquired based upon the two frames.

As can be apparent from the foregoing analysis, a zoom motion parameter between adjacent frames in the video can be estimated by firstly estimating a motion vector of each image block with respect to adjacent frames in the video, then converting it in the formula (1) and next deriving div according to the formula (2). Assumed that there are a total number, 10, of frames in the video (of course, the number of frames in practice may be far larger than this number which is assumed here merely as an example for convenience of the description), there are nine pairs of adjacent frames, and therefore nine zoom motion parameters for the adjacent frames can be calculated. For example, a zoom motion parameter between a first frame and a second frame can be represented as div₁₂, a zoom motion parameter between the second frame and a third frame can be represented as div₂₃, and so on.

The step S102 is to estimate a second zoom motion parameter between frames having an interval of a preset number in a corresponding video segment by a second estimating unit when the first zoom motion parameter meets a first preset condition.

The step S103 is to identify the camera motion type of the video segment as slow zoom by a determining unit when the second zoom motion parameter meets a second preset condition.

Particularly the first preset condition can be that the first zoom motion parameter is above a certain first preset threshold which can be somewhat smaller than the threshold in the prior art. If the parameter is above the first preset threshold, then it means that the corresponding video segment may be of zoom motion but will be subject to further detection. Of course the first preset condition can be set in an alternative form. For example, it can be determined that the condition is met only if zoom motion parameters of a number of adjacent consecutive frames are above the first preset threshold; or another condition can be set in response to the result of comparing the first zoom motion parameter with the first preset threshold in terms of their magnitudes, or the like. The embodiments will not be limited in this respect.

For convenient understanding, firstly the meaning of “video segment” here will be introduced below. A video segment is composed of a part of frames in a video, and the “corresponding video segment when the first zoom motion parameter meets the first preset condition” refers to a video segment composed of frames corresponding to the first zoom motion parameter meeting the first preset condition. For example, the calculated div₁₂, div₂₃, div₃₄ and div₄₅ all meet the first preset condition, and then the corresponding video segment can refer to a segment composed of the first to fourth frames in the video. Of course, it can alternatively refer to a segment composed of the second to fifth frames or a segment composed of the first to fifth frames, or the like. That is, for a motion parameter estimated with respect to two adjacent frames, the motion parameter can correspond to the preceding frame, the succeeding frame or both without any substantial influence in practice (because a real video typically includes a number of frames and the effect of one or two frames can be neglected for observation by human eyes). According to the embodiments, assumed that the parameter corresponds to two frames, then the corresponding video segment is equivalent to a segment composed of the first to fifth frames in the video.

That is, it is preliminarily determined that the segment composed of the first to fifth frames in the video may or may not be of the motion type of slow zooming and therefore will be needed to subject to further determination in the embodiment. Specifically the second zoom motion parameter between every other preset number of frames is estimated for this video segment. Particularly the preset data can be set as required in practice (e.g., in view of a factor, e.g., a frame rate, etc.), and the embodiments will not be limited in this respect.

For example assumed that the parameter is a zoom motion parameter for every other two frames, and then equivalently in the foregoing example, the zoom motion parameter div₁₄ between the first and fourth frames and the zoom motion parameter div₂₅ between the second and fifth frames are estimated, and then it is further determined whether the two zoom motion parameters meet a second preset condition. Particularly the second preset condition can also be set for a second threshold. For example, if the second zoom motion parameter is above the second threshold, then it meets the second preset condition, or the second preset condition is met when a number of consecutive second zoom motion parameters are all above the second preset threshold, or the like. In other words, assumed that both div₁₄ and div₂₅ are above a certain second threshold, and then the camera motion type corresponding to the video segment composed of the first to fifth frames is determined as slow zooming.

Particularly the foregoing method can also be applicable to estimation of a zoom motion parameter for every other several frames. For example, the zoom motion parameter div₁₄ between the first and fourth frames can be estimated by firstly estimating the motion vector of an image block between the first and fourth frames, then expressing the motion vector in the formula (1) and then deriving the corresponding zoom motion parameter, i.e., div₁₄, according to the formula (2). This also applies to the zoom motion parameters between the other frames.

It shall be noted in the foregoing method according to the embodiment, it is equivalent to a new detection method provided for a special camera motion type, i.e., slow zooming, without any confliction with the traditional method for detecting the type of zoom motion. For example in a detection process, firstly it can be determined whether an acquired zoom motion parameter between adjacent frames meets the traditional condition of zooming detection, and if so, then the process continues for other frames; otherwise, it is determined whether the parameter meets the first preset condition in the embodiment, and if so, then a zoom motion parameter between every other several frames is acquired and it is further determined whether the acquired zoom motion parameter meets the second preset condition in the embodiment, and if so, then a corresponding video segment is determined to be of the motion type of slow zooming.

It shall further be noted that in the embodiment, zooming is divided into two categories, one of which is for the purpose of scaling up an image and referred to as focusing, and on the contrary, the other of which is for the purpose of scaling down the image, so the value of an estimated zoom motion parameter div may be positive or negative. Therefore in the case of being compared with a preset threshold, the absolute value of div is compared with the preset threshold, and in the case that its magnitude meets the condition, it can further be determined from the positive or negative sign of div whether focusing or zooming contrary thereto is active.

Of course no matter whether determination is made with respect to the first preset condition or the second preset condition, such a precondition applies that both a₂ and a₆ as estimated to have the same sign (both are positive or negative) because a corresponding camera motion type will be zooming only if the two parameters have the same sign.

As can be apparent, an effective detection method can be provided for the relatively special camera motion type, i.e., slow zooming, in the embodiment, and therefore the effectiveness and accuracy of detection can be improved over the method being capable of detecting only standard zoom motion.

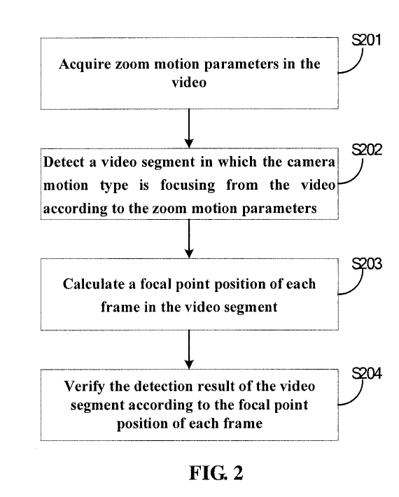

In view of the other problem present in the prior art as described above, an embodiment further provides another method for detecting a camera motion type in a video, and referring to FIG. 2, this method includes the following steps.

The step S201 is to acquire zoom motion parameters in the video by a motion parameter acquiring unit.

The step S202 is to detect a video segment in which the camera motion type is focusing from the video according to the zoom motion parameters by a motion type detecting unit.

Both a zoom motion parameter can be acquired in the step S201 and a video segment with the camera motion type being focusing included in the video can be detected in the step S202 particularly as in the prior art. Of course, the foregoing method can apply thereto if identification of the motion type of slow zooming is required.

The step S203 is to calculate a focal point position of each frame in the video segment by a focal point position calculating unit.

The step S204 is to verify the detection result of the video segment according to the focal point position of each frame by a detection result verifying unit.

As described at the beginning of the detailed description of the embodiments, the type of zoom motion may be determined as a false positive, and actually it may be a type of translational motion, and the photographer has the camera so declined that a photographed scene is unparallel with the focal plane of the camera.

Therefore in order to avoid such an error, a video segment detected as the type of focusing in initial detection will be subject to further detection in the embodiment. Specifically, focal positions of respective frames in the video segment with the detection result of focusing are calculated, and if zoom motion is active indeed, then the focal point positions of the respective frames will not change obviously; otherwise, if an object gradually becomes larger due to the photographed scene being unparallel to the focal plane of the camera, then the focal point positions of the respective frames corresponding thereto will change considerably, and therefore the detection result of the video segment detected as the type of focusing can be further verified in view of the variation in the positions of the focal points.

Specifically, if the positional differences of the focal points between the respective frames are below a preset threshold, then the detection result of the video segment is determined as focusing. For example, after the positions of the focal points of the respective frames are calculated, the positions of the focal points between every two adjacent frames can be compared, and if the positions of the focal points between every two adjacent frames change little, then the camera motion type corresponding to the video segment can be determined as focusing; or if the positions of the focal points between every two adjacent frames change considerably, then the camera motion type corresponding to the video segment can be determined as other than focusing. Of course for comparison of the differences between the positions of the focal points of the respective frames, adjacent frames may not necessarily be selected for comparison, but, for example, several frames can alternatively be selected for comparison of the positions of the focal points, etc., in order to reduce the effort of calculation and improve the efficiency, and the embodiment will not be limited in this respect.

Particularly the positions of focal points of respective frames can be calculated in the following method.

Assumed that the coordinates of the focal point position of the camera are (x₀, y₀), the following motion model is taken into account:

$$\{ \begin{matrix}u = {b}_{1} + {b}_{2} ( x - {x}_{0} ) + {b}_{3} ( y - {y}_{0} ) \\ v = {b}_{4} + {b}_{5} ( x - {x}_{0} ) + {b}_{6} ( y - {y}_{0} )\end{matrix} \qquad ( 3 )$$

That is:

$$\{ \begin{matrix}u = ( {b}_{1} - {b}_{2} {x}_{0} - {b}_{3} {y}_{0} ) + {b}_{2} x + {b}_{3} y \\ v = ( {b}_{4} - {b}_{5} {x}_{0} - {b}_{6} {y}_{0} ) + {b}_{5} x + {b}_{6} y\end{matrix} \qquad ( 4 )$$

In view of a correspondence relationship between the model and the model illustrated in the formula (1), the following formula holds true:

$$\{ \begin{matrix}{b}_{1} = {a}_{1} + {a}_{2} {x}_{0} + {a}_{3} {y}_{0} \\ {b}_{2} = {a}_{2} \\ {b}_{3} = {a}_{3} \\ {b}_{4} = {a}_{4} + {a}_{5} {x}_{0} + {a}_{6} {y}_{0} \\ {b}_{5} = {a}_{5} \\ {b}_{6} = {a}_{6}\end{matrix} \qquad ( 5 )$$

When the camera is subject to zooming,

$$\{ \begin{matrix}{b}_{1} = 0 \\ {b}_{4} = 0\end{matrix} \qquad ( 6 )$$

That is:

$$\{ \begin{matrix}{a}_{1} + {a}_{2} {x}_{0} + {a}_{3} {y}_{0} = 0 \\ {a}_{4} + {a}_{5} {x}_{0} + {a}_{6} {y}_{0} = 0\end{matrix} \qquad ( 7 )$$

The foregoing set of linear equations can be solved to derive the positional coordinates of a focal point.

Of course the positions of the focal points of the respective frames can be calculated otherwise, and the embodiments will not be limited in this respect.

It shall be noted that a video segment determined in the verification process as other than the type of focusing motion can be subject to another round of detection regarding whether it is of another camera motion type, e.g., rotation, translation or resting, particularly as in the prior art, and a repeated description thereof will be omitted here.

Apparently with the embodiment, it is possible to prevent a translated segment acquired by photographing when the camera is declined from being mistaken for a focused-on segment, thereby offering effective and accurate detection.

In correspondence to the first method for detecting a camera motion type in a video according to the embodiment, an embodiment further provides an apparatus for detecting a camera motion type in a video, which as illustrated in FIG. 3 includes: a first estimating unit 301 configured to estimate a first zoom motion parameter between adjacent frames in the video; a second estimating unit 302 configured to estimate a second zoom motion parameter between frames having an interval of a preset number in a corresponding video segment when the first zoom motion parameter meets a first preset condition; and a determining unit 303 configured to identify the camera motion type of the video segment as slow zoom when the second zoom motion parameter meets a second preset condition.

Particularly the second estimating unit 302 can be configured to estimate the second zoom motion parameter between every other preset number of frames in the corresponding video segment when the first zoom motion parameter is above a first preset threshold.

Particularly the determining unit 303 can be configured to identify the camera motion type of the video segment as slow zooming when the second zoom motion parameter is above a second preset threshold.

That is, firstly a small threshold can be set, and a zoom motion parameter between adjacent frames is calculated and then compared with the small threshold (smaller than the standard threshold for use in detection of standard zoom motion), and if the parameter is above the threshold, then it is determined that slow zooming may be active, and of course another type of motion may be active but mistaken for slow zooming due to inaccurate estimation of the motion parameter resulting from noise, etc. Therefore further verification is necessary in the embodiment, and specifically a slightly larger threshold (which may approach the standard threshold for use in detection of standard zoom motion) can be set, and then the zoom motion parameter of every other several frames can be estimated and compared with the threshold, and if the parameter is above the threshold, then the result of detection can be equivalently verified and the camera motion type of the corresponding video segment can be determined as slow zooming.

As can be apparent in the foregoing apparatus according to the embodiment, the motion type of slow zooming can be detected in a “dual zoom motion parameters” way, where firstly the first zoom motion parameter between adjacent frames is estimated, and then in the case that the parameter meets the first preset condition, the second zoom motion parameter between every other several frames is further estimated, and if the second zoom motion parameter meets the second preset condition, then the camera motion type can be identified as slow zooming in the video segment corresponding to these frames. Apparently the motion type of slow zooming can be identified accurately with the apparatus according to the embodiment.

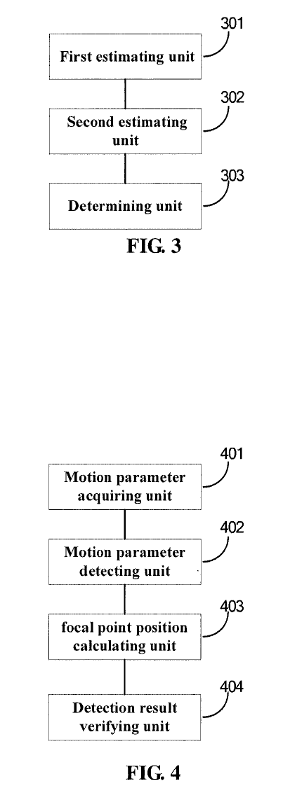

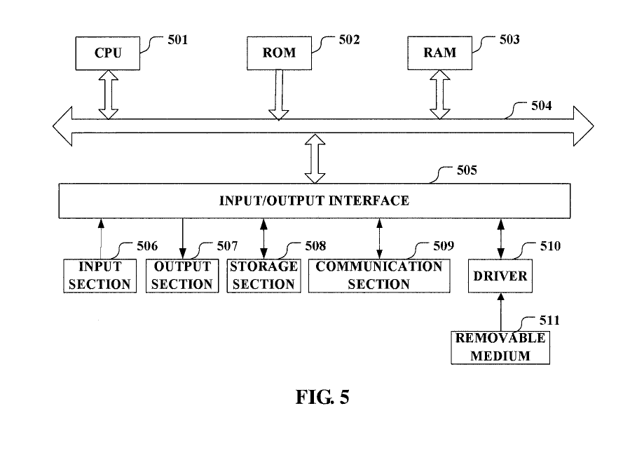

In correspondence to the other method for detecting a camera motion type in a video according to the embodiment, an embodiment further provides another apparatus for detecting a camera motion type in a video, which as illustrated in FIG. 4 includes: a motion parameter acquiring unit 401 configured to acquire camera motion parameters in the video; a motion type detecting unit 402 configured to detect a video segment in which the camera motion type is focusing in the video according to the zoom motion parameters; a focal point position calculating unit 403 configured to calculate for a video segment with the detection result of focusing a focal point position of each frame in the video segment; and a detection result verifying unit 404 configured to verify the detection result of the video segment according to focal point position of each frame in the video segment.

Particularly the detection result verifying unit 404 can be configured to: if the positional differences of the focal points between the respective frames are below a preset threshold, then the camera motion type in the video segment is determined as focusing.

As can be apparent in the foregoing apparatus according to the embodiment, the detection result of the camera motion type in the video file is acquired with the motion parameter, and then for the video segment with the detection result of focusing, the positions of focal points of respective frames in the video segment are further calculated, and then the detection result of the video segment is verified according to the positions of the focal points of the respective frames. Apparently with the embodiment, whether the motion type corresponding to the video segment is focusing motion indeed can be further verified, thereby improving the accuracy of detection.

It shall be noted that the apparatus according to the embodiment corresponds to the foregoing method of the embodiment, and therefore for those parts which have not been described in details in the embodiment of the apparatus, reference can be made to the corresponding description in the embodiment of the method, and a repeated description thereof will be omitted here.

Furthermore it shall be noted that the foregoing series of processes and apparatuses can also be embodied in software and/or firmware. In the case of being embodied in software and/or firmware, a program constituting the software is installed from a storage medium or a network to a computer with a dedicated hardware structure, e.g., a general purpose personal computer 500 illustrated in FIG. 5, which can perform various functions when various programs are installed thereon.

In FIG. 5, a Central Processing Unit (CPU) 501 performs various processes according to a program stored in a Read Only Memory (ROM) 502 or loaded from a storage section 508 into a Random Access Memory (RAM) 503 in which data required when the CPU 501 performs various processes is also stored as needed.

The CPU 501, the ROM 502 and the RAM 503 are connected to each other via a bus 504 to which an input/output interface 505 is also connected.

The following components are connected to the input/output interface 505: an input section 506 including a keyboard, a mouse, etc.; an output section 507 including a display, e.g., a Cathode Ray Tube (CRT), a Liquid Crystal Display (LCD), etc., a speaker, etc.; a storage section 508 including a hard disk, etc.; and a communication section 509 including a network interface card, e.g., an LAN card, a modem, etc. The communication section 509 performs a communication process over a network, e.g., the Internet.

A driver 510 is also connected to the input/output interface 505 as needed. A removable medium 511, e.g., a magnetic disk, an optical disk, a magneto optical disk, a semiconductor memory, etc., can be installed on the driver 510 as needed so that a computer program read therefrom can be installed into the storage section 508 as needed.

In the case that the foregoing series of processes are performed in software, a program constituting the software is installed from a network, e.g., the Internet, etc., or a storage medium, e.g., the removable medium 511, etc.

Those skilled in the art shall appreciate that such a storage medium will not be limited to the removable medium 511 illustrated in FIG. 5 in which the program is stored and which is distributed separately from the device to provide a user with the program. Examples of the removable medium 511 include a magnetic disk (including a Floppy Disk (a registered trademark)), an optical disk (including Compact Disk-Read Only memory (CD-ROM) and a Digital Versatile Disk (DVD)), a magneto optical disk (including a Mini Disk (MD) (a registered trademark)) and a semiconductor memory. Alternatively the storage medium can be the ROM 502, a hard disk included in the storage section 508, etc., in which the program is stored and which is distributed together with the device including the same to the user.

It shall further be noted that the steps of the foregoing series of processes may naturally but not necessarily be performed in the sequential order as described. Some of the steps may be performed concurrently or separately from each other.

Although the embodiments and the advantages thereof have been described in details, it shall be appreciated that various modifications, substitutions and variations can be made without departing from the spirit and scope of the embodiments as defined in the appended claims. Furthermore the terms “include”, “comprise” and any variants thereof in the embodiments are intended to encompass nonexclusive inclusion so that a process, method, article or device including a series of elements includes both those elements and other elements which are not listed explicitly or an element(s) inherent to the process, method, article or device. Unless stated otherwise, an element being defined in a sentence “include/comprise a(n) . . . ” will not exclude presence of an additional identical element(s) in the process, method, article or device including the element.

1. A method for detecting a camera motion type in a video, comprising:
estimating a first zoom motion parameter between adjacent frames in the video;
estimating a second zoom motion parameter between frames having an interval of a preset number in a corresponding video segment when the first zoom motion parameter meets a first preset condition; and
identifying the camera motion type of the video segment as slow zoom when the second zoom motion parameter meets a second preset condition.

2. The method according to claim 1, wherein estimating a second zoom motion parameter between frames having an interval of a preset number in a corresponding video segment when the first zoom motion parameter meets a first preset condition comprises:
estimating the second zoom motion parameter between the frames having the interval of the preset number in the corresponding video segment when the first zoom motion parameter is greater than a first preset threshold.

3. The method according to claim 1, wherein identifying the camera motion type of the video segment as slow zoom when the second zoom motion parameter meets a second preset condition comprises:
identifying the camera motion type of the video segment as slow zoom when the second zoom motion parameter is greater than a second preset threshold.

4. A method for detecting a camera motion type in a video, comprising:
acquiring zoom motion parameters in the video;
detecting a video segment in which the camera motion type is focusing from the video according to the zoom motion parameters;
calculating a focal point position of each frame in the video segment; and
verifying the detection result of the video segment according to the focal point position of each frame.

5. The method according to claim 4, wherein verifying the detection result of the video segment according to the focal point position of each frame comprises:
if a variation of the focal point position of each frame is less than a preset threshold, determining the camera motion type in the video segment as focusing.

6. An apparatus for detecting a camera motion type in a video, comprising:
a first estimating unit, configured to estimate a first zoom motion parameter between adjacent frames in the video;
a second estimating unit, configured to estimate a second zoom motion parameter between frames having an interval of a preset number in a corresponding video segment when the first zoom motion parameter meets a first preset condition; and
a determining unit, configured to identify the camera motion type of the video segment as slow zoom when the second zoom motion parameter meets a second preset condition.

7. The apparatus according to claim 6, wherein the second estimating unit is specifically configured to estimate the second zoom motion parameter between the frames having the interval of the preset number in the corresponding video segment when the first zoom motion parameter is greater than a first preset threshold.

8. The apparatus according to claim 6, wherein the determining unit is specifically configured to identify the camera motion type of the video segment as slow zoom when the second zoom motion parameter is greater than a second preset threshold.
